(19) United States
(12) Patent Application Publication
(10) Pub. No.: US 2011/0130953 A1
(43) Pub. Date: Jun. 2, 2011

(54) NAVIGATION EQUIPMENT AND NAVIGATION SYSTEM

(75) Inventors: Hironori Ohishi, Tokyo (JP); Yohei Nakajima, Tokyo (JP); Mizuki Tomono, Tokyo (JP); Kazushi Tahara, Saitama (JP); Hirofumi Tanigawa, Saitama (JP); Takashi Aoki, Saitama (JP); Kazuyoshi Yamazaki, Saitama (JP)

(73) Assignees: PIONEER CORPORATION, Kawasaki-shi, Kanagawa (JP); PIONEER DESIGN CORPORATION, Tokyo (JP)

(21) Appl. No.: 12/995,330

(22) PCT Filed: Jun. 2, 2008
(86) PCT No.: PCT/JP2008/060158

§ 371 Date: Feb. 16, 2011

(51) Int. Cl. G01C 21/00; G06F 17/30

(52) U.S. Cl. 701/200; 707/769; 707/E17.014

(57) ABSTRACT

The server apparatus has a life log database storing life log data indicating user behavior history. The server apparatus receives the related information request from the navigation apparatus, and searches the life log database based on the related information request to obtain the related information including the place information. Then, the server apparatus transmits the related information to the navigation apparatus. On the other hand, the navigation apparatus sets the guiding route based on the user's input, and generates the route information. The navigation apparatus obtains the ID information from the user's mobile terminal, and transmits the related information request including the ID information and the route information to the server apparatus. Further, when receiving the related information from the server apparatus, the navigation apparatus determines the candidate of the stop-by place based on the place information included in the related information, and displays the candidate on the display device.

### TECHNICAL FIELD

The present invention relates to a navigation apparatus utilizing life log data.

### BACKGROUND TECHNIQUE

Recently, it is proposed to generate and store a record of user's behavior history (called as “life log”) by utilizing a mobile terminal such as a mobile phone. By collecting the life log data, obtained by the user living with the mobile terminal, to the server, it is possible to create a database related to the user's behavior history. Since the user's personal favor and inclination are reflected to the life log data thus collected, it is possible to provide the user with useful information by utilizing the life log data in the route guidance by the navigation apparatus.

The Patent Reference 1 discloses an example of a database system having a life log database.

### Patent Reference 1:

Japanese Patent Application Laid-open under No. 2007-293768

### DISCLOSURE OF INVENTION

### Problem to be Solved by the Invention

The above is one of the problem to be solved by the present invention. It is an object of the present invention to provide a navigation system capable of presenting useful information by utilizing the life log data of the user.

### Means for Solving the Problem

The invention of claim 1 is a navigation apparatus capable of communicating with a server apparatus, comprising: an ID information obtaining means which obtains ID information identifying a user from a mobile terminal of the user; a route information generating means which generates route information; a related information requesting means which transmits a related information request which includes the ID information and the route information and which requests related information; a receiving means which receives, from the server apparatus, the related information which is obtained by searching a life log database based on the related information request and which includes place information; and a display control means which displays the place included in the related information received from the server apparatus on a display device as candidate of a stop-by place.

The invention of claim 6 is a navigation program executed by a navigation apparatus capable of communicating with a server apparatus, the program makes the navigation apparatus function as: an ID information obtaining means which obtains ID information identifying a user from a mobile terminal of the user; a route information generating means which generates route information; a related information requesting means which transmits a related information request which includes the ID information and the route information and which requests related information; a receiving means which receives, from the server apparatus, the related information which is obtained by searching a life log database based on the related information request and which includes place information; and a display control means which displays the place included in the related information received from the server apparatus on a display device as candidate of a stop-by place.

The invention of claim 7 is a navigation system comprising a navigation apparatus and a server apparatus, wherein the server apparatus comprises: a life log database which stores life log data indicating behavior history of user; a receiving means which receives a related information request from the navigation apparatus; a search means which searches the life log database based on the related information request to obtain related information including place information; and a transmitting means which transmits the related information to the navigation apparatus, wherein the navigation apparatus comprises: an ID information obtaining means which obtains ID information identifying a user from a mobile terminal of the user; a route information generating means which generates route information; a related information requesting means which transmits a related information request which includes the ID information and the route information and which requests related information; and a display control means which receives the related information from the server apparatus, and displays the place included in the related information on a display device as candidate of a stop-by place.

### BRIEF DESCRIPTION OF THE DRAWINGS

FIGS. 1A and 1B show a schematic configuration of a navigation system.

FIG. 2 schematically shows an interior of a vehicle on which a navigation apparatus is loaded.

FIG. 3 shows an example of life log data.

FIGS. 4A to 4C show examples of registering process of the life log data.

FIGS. 5A to 5C show the examples of the life log data, behavior linkage information and related information.

FIG. 6 shows an example of navigation process using the life log data.

FIG. 7 is a flowchart of the search process shown in FIG. 6.

FIGS. 8A and 8B show registering process of the life log data.

FIGS. 9A and 9B show examples of the life log data.

FIGS. 10A and 10B show examples of the life log data and the related information.

FIG. 11 shows an example of navigation process utilizing the life log data.

FIG. 12 is a flowchart of the search process shown in FIG. 11.

FIG. 13 is a display example of stop-by places.

FIG. 14 shows another example of navigation process utilizing the life log data.

FIGS. 15A and 15B show display examples during the navigation process.

FIGS. 16A and 16B show display examples during the navigation process.

FIGS. 17A and 17B show display examples during the navigation process.

### DESCRIPTON OF REFERENCE NUMBERS

10 Life Log Server

12 Life Log Database

13 Behavior Linkage Information Database

14 Related Information Database

20 Mobile Terminal

30 Car Navigation Apparatus

31 Monitor

32 Reader

34 Controller

### MOST PREFERRED FORM TO EXERCISE THE INVENTION

According a preferred aspect of the present invention, there is provided a navigation apparatus capable of communicating with a server apparatus, comprising: an ID information obtaining means which obtains ID information identifying a user from a mobile terminal of the user; a route information generating means which generates route information; a related information requesting means which transmits a related information request which includes the ID information and the route information and which requests related information; a receiving means which receives, from the server apparatus, the related information which is obtained by searching a life log database based on the related information request and which includes place information; and a display control means which displays the place included in the related information received from the server apparatus on a display device as candidate of a stop-by place.

The above navigation apparatus sets the guiding route based on the user's input, and generates the route information. In addition, the navigation apparatus obtains the ID information from the mobile terminal of the user, and transmits the related information request including the ID information and the route information to the server apparatus. The server apparatus searches the life log database of the user based on the related information request, and transmits the related information to the navigation apparatus. The navigation apparatus determines the candidate of the stop-by place based on the place information in the related information, and displays it on the display device.

In one mode of the above navigation apparatus, the display control means displays the candidates of the stop-by place related to plural users on a same map image. In this mode, the candidate of the stop-by place can be obtained based on the life log data of plural users.

In a preferred example, the display control means displays the candidates of the stop-by place related to each user in a different display manner distinguished from each other. Therefore, each user can discriminate that the plural candidates of the stop-by place displayed on the display device relate to the life log data of which user, respectively.

In a preferred example, the display control means displays the candidate of each stop-by place by a balloon associated with a corresponding geographic position on a map. In another preferred example, the display control means displays a list display area which displays each candidate of the stop-by place as a list in a traveling order indicated by the route information.

According to another preferred aspect of the present invention, there is provided a navigation program executed by a navigation apparatus capable of communicating with a server apparatus, the program makes the navigation apparatus function as: an ID information obtaining means which obtains ID information identifying a user from a mobile terminal of the user; a route information generating means which generates route information; a related information requesting means which transmits a related information request which includes the ID information and the route information and which requests related information; a receiving means which receives, from the server apparatus, the related information which is obtained by searching a life log database based on the related information request and which includes place information; and a display control means which displays the place included in the related information received from the server apparatus on a display device as candidate of a stop-by place.

By executing the navigation program on the navigation apparatus, the above navigation apparatus can be realized.

According to still another preferred aspect of the present invention, there is provided a navigation system comprising a navigation apparatus and a server apparatus, wherein the server apparatus comprises: a life log database which stores life log data indicating behavior history of user; a receiving means which receives a related information request from the navigation apparatus; a search means which searches the life log database based on the related information request to obtain related information including place information; and a transmitting means which transmits the related information to the navigation apparatus, wherein the navigation apparatus comprises: an ID information obtaining means which obtains ID information identifying a user from a mobile terminal of the user; a route information generating means which generates route information; a related information requesting means which transmits a related information request which includes the ID information and the route information and which requests related information; and a display control means which receives the related information from the server apparatus, and displays the place included in the related information on a display device as candidate of a stop-by place.

In this navigation system, the server apparatus has a life log database which stores life log data indicating the behavior history of a user. The server apparatus receives the related information request from the navigation apparatus, and searches the life log database based on the related information request to obtain the related information including the place information.

Then, the server apparatus transmits the related information to the navigation apparatus.

On the other hand, the navigation apparatus sets the guiding route based on the user's input, and generates the route information. The navigation apparatus obtains the ID information from the user' s mobile terminal, and transmits the related information request including the ID information and the route information to the server apparatus. Further, when receiving the related information from the server apparatus, the navigation apparatus determines the candidate of the stop-by place based on the place information included in the related information, and displays the candidate on the display device.

### EMBODIMENT

A preferred embodiment of the present invention will be described below with reference to the attached drawings.

[System Configuration]

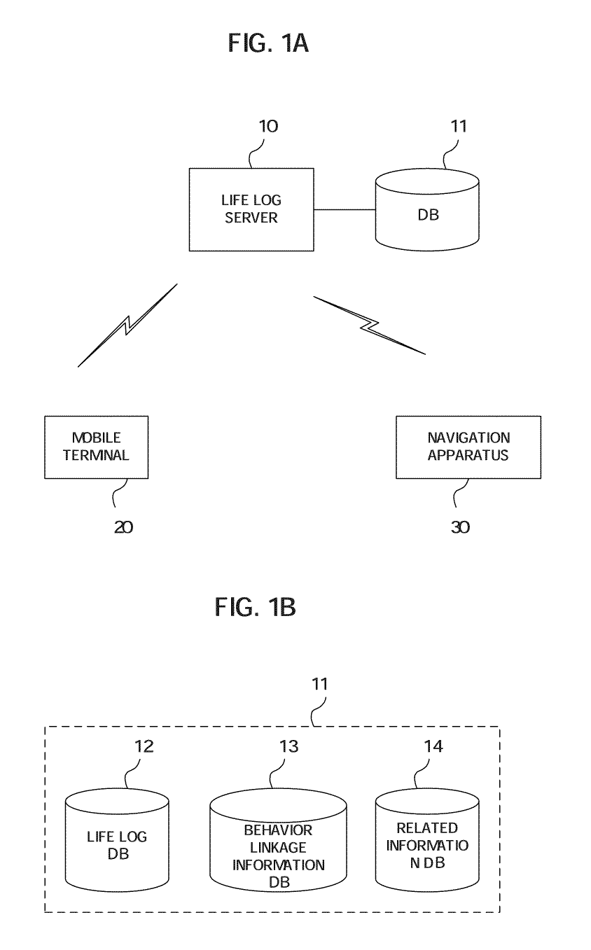

FIG. 1A shows a schematic configuration of a navigation system to which the present invention is applied. As shown, the navigation system includes a server apparatus including a life log server 10 anda database 11, amobile terminal 20, and a navigation apparatus 30.

The mobile terminal 20 is a mobile phone owned by the user, for example, and the user uses it in each situation of his or her life. The mobile terminal 20 stores ID information which is identification information of the user or the mobile terminal. The ID information is read out from the mobile terminal 20 as needed, and the certification process by the ID information is executed. When the user performs various behaviors by using the mobile terminal 20, the behavior history data is obtained and is registered in the life log server 10. The mobile terminal 20 can communicate with the life log server 10 by wireless transmission.

When the user behaves using the mobile terminal 20, the life log server 10 receives the behavior history data from the mobile terminal 20 or other server, and accumulates it in the database 11 as the life log data. In addition, the life log server 10 receives the request of the related information from the navigation apparatus 30, and generates the related information based on the life log data and supplies it to the navigation apparatus 30. The life log server 10 executes each of the following processes by executing the program prepared in advance.

The navigation apparatus 30 is loaded on the vehicle, and executes various processes such as the map display and the route guidance. The navigation apparatus 30 can communicate with the life log server 10 by its communication function.

In the above-mentioned configuration, the life log server 10 functions as the receiving means, the searching means and the transmitting means of the present invention. The navigation apparatus 30 functions as the ID information obtaining means, the route information generating means, the related information requesting means, the receiving means and the display control means.

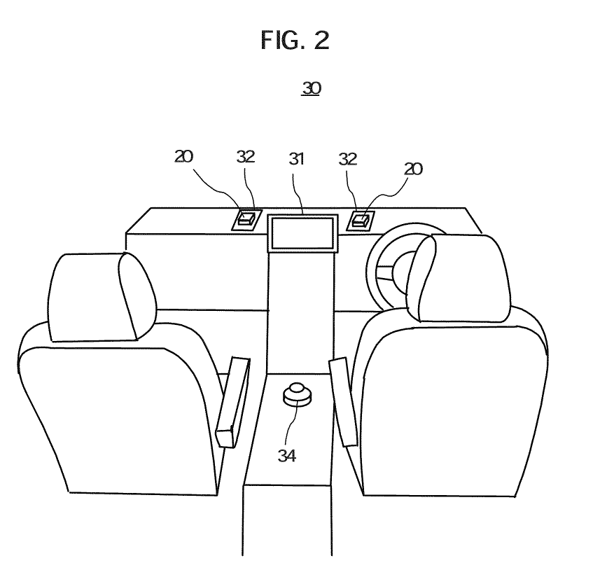

FIG. 2 schematically shows the interior of the vehicle on which the navigation apparatus 30 is loaded. In FIG. 2, the body unit of the navigation apparatus 30 is arranged at a hidden position in the interior of the vehicle. The navigation apparatus 30 includes a monitor 31 such as an LCD, a reader 32 which transmits and receives the information by the communication with the mobile terminal 20, and a controller 34 operated by the user. In the example of FIG. 2, the reader 32 is arranged on the dashboard in the interior of the vehicle, and the controller 34 is arranged between the driver's seat and the assistant driver's seat. The user performs the input and the selection to the navigation apparatus 30 by operating the controller 34 with watching the monitor 31.

Next, the database 11 will be described in detail. FIG. 1B shows the configuration of the database 11. The database 11 includes a life log database (DB) 12, a behavior linkage information DB 13 and a related information DB 14.

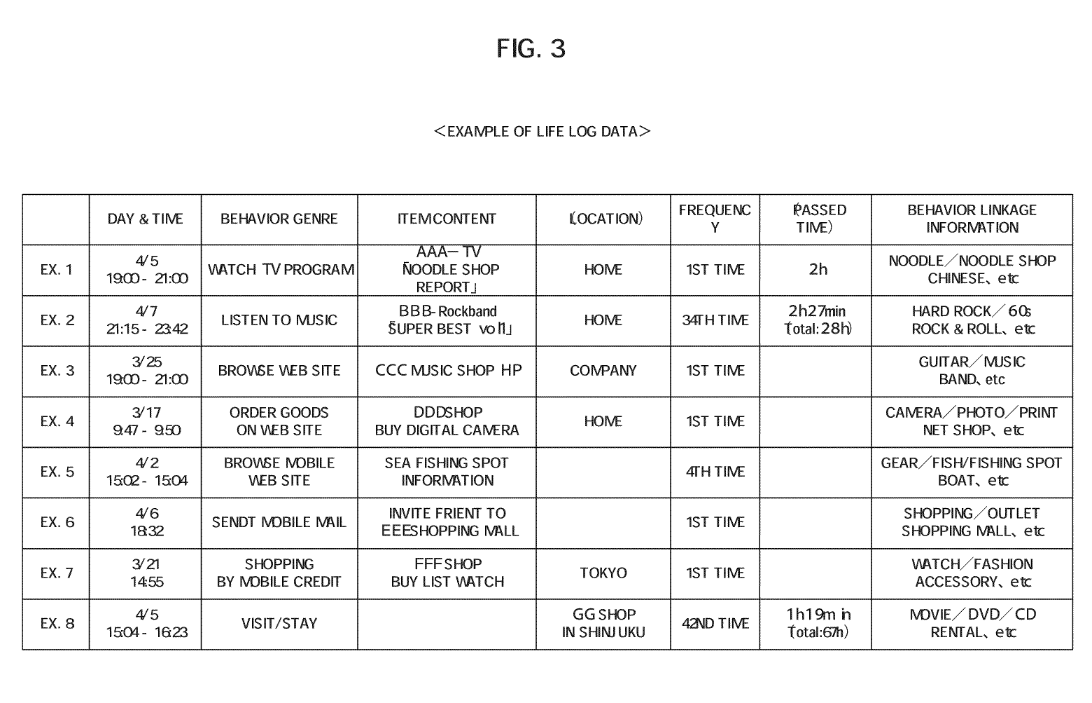

The life log DB 12 stores the life log data of each user, for each ID information. FIG. 3 shows an example of the life log data stored in the life log DB 12. This is the life log data of a certain user.

The life log data includes “DAY AND TIME”, “BEHAVIOR GENRE”, “ITEM CONTENT”, “FREQUENCY” and “HEBAVIOR LINKAGE INFORMATION” as the mandatory items, and includes “LOCATION” and “PASSED TIME” as the optional items.

The example 1 is the life log data obtained when the user watches TV program at home. In a circumstance where the mobile terminal, the PC, the TV and the HDD recorder form a network by DLNA (Digital Living Network Alliance) for example, the watching history of TV programs by the user can be obtained and registered in the life log server 10.

The example 2 is the life log data obtained when the user listens to the music at home. In a circumstance where the mobile terminal, the PC, the TV, the HDD recorder and the audio equipment form a network, the history of the music source that the user listens to can be obtained and registered in the life log server 10.

The example 3 is the life log data obtained when the user browses the WEB site. In a circumstance where the mobile terminal and the PC form a network, the history of the WEB sites that the user browses can be obtained and registered in the life log server 10.

The example 4 is the life log data obtained when the user purchases goods on the WEB site. In a circumstance where the mobile terminal and the PC form a network, the history of the purchase by the internet shopping can be obtained and registered in the life log server 10.

The example 5 is the life log data obtained when the user browses the WBE site for mobile phone. The history of the WEB sites that the user browses by the mobile phone is registered in the life log server 10.

The example 6 is the life log data obtained when the user sends a mail by the mobile phone. In a case that the place name is included in the sentences of the mail, the mobile phone transmits the mail data to the life log server 10, and the life log server 10 registers it as the life log data.

The example 7 is the life log data obtained when the user purchases goods at a shop using the credit function of the mobile phone. When the user purchases goods using the mobile phone, the mobile phone transmits the history of the purchase to the life log server 10.

The example 8 is the life log data obtained when the user stays at a certain shop for a constant time period. The mobile phone utilizes the GPS function, and transmits the behavior history indicating when, where and how long the user stays, to the life log server 10.

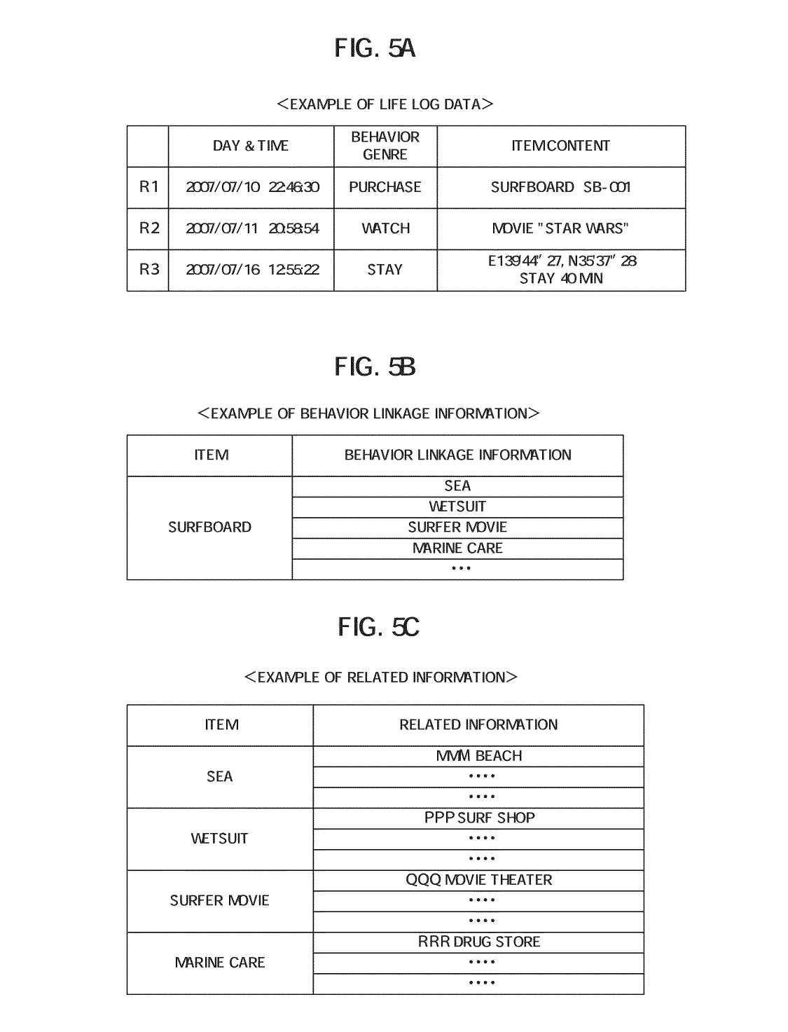

The behavior linkage information DB 13 stores the correspondence between the items included in the “item content” of the life log data and the related item relating to the item. An example of the behavior linkage information DB 13 is shown in FIG. 5B. In this example, the behavior linkage information “SEA” and “WETSUIT” are registered for the item “SURFBOARD”.

The related information DB 14 stores the correspondence between the behavior linkage information registered in the behavior linkage information DB 13 and the related information relating to the behavior linkage information. An example of the related information DB 14 is shown in FIG. 5C. In this example, the related information are stored for the items “SEA” and “WETSUIT”, etc. The related information is mainly the information of facility, and includes its place information.

[Register Process of Life Log Data]

Next, the description will be given of the process to register the life log data in the life log server 10.

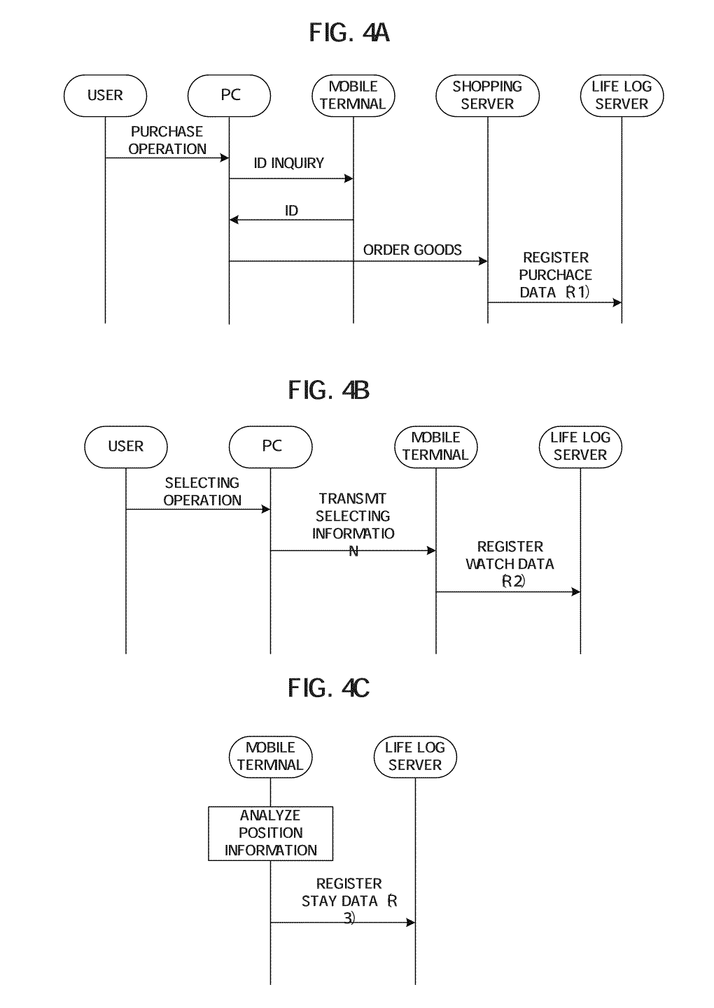

FIG. 4A shows the registering process of the life log data when the user did the internet shopping. When the user operates the PC to instruct the purchase of goods, the PC inquires the user's mobile terminal 20 the ID information. The mobile terminal 20 returns the ID information to the PC, and the PC executes the user certification. When the user certification is completed, the PC orders the goods to the shopping server. When receiving the order, the shopping server transmits the purchase data to the life log server 10. The life log data thus obtained is registered in the life log DB 12 as shown in FIG. 5A (see. item R1). In the above example, the certification by the ID information is executed every time the user makes purchase operation. Alternatively, the user certification is executed when the user makes the user registration of the shopping site, and the user certification may be omitted when the user uses the site after that.

FIG. 4B shows the registering process of the life log data when the user watches the TV. In this example, the TV is connected with the mobile terminal 20 via a network. When the user selects the channel of the TV, the TV transmits the channel selection information to the mobile terminal 20 via the network. The mobile terminal 20 transmits the watching data to the life log server 10. The life log data thus obtained is registered in the life log DB 12 as shown in FIG. 5A (see. item R2).

In the case that the TV is connected to the network, the TV can directly transmit the channel selection information to the life log server 10. In the case that the mobile terminal 20 itself operates as the remote-controller of the TV, the mobile terminal 20 can transmits the channel selection information to the life log server 10, even if the TV and the mobile terminal 20 are not connected with each other by the network.

FIG. 4C shows the registering process of the life log data by utilizing the GPS function of the mobile terminal 20. The GPS function of the mobile terminal 20 obtains the position information, and transmits the stay data to the life log server 10 when a certain condition is satisfied. The certain condition may include the condition that the user stays in a certain area, or that the user continuously stays at the same location for more than a predetermined time. The life log data thus obtained is registered in the life log DB 12 as shown in FIG. 5A (see. item R3).

[Navigation Process Utilizing Life Log Data]

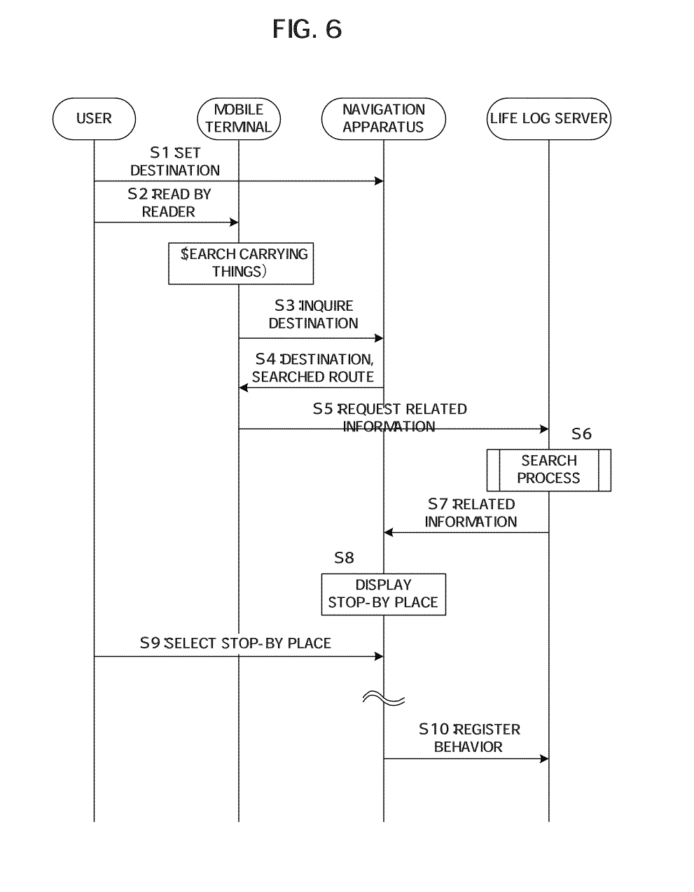

Next, the navigation process utilizing the life log data will be described. FIG. 6 shows the flow of the navigation process. First, the user operates the navigation apparatus 30 and sets a destination (step S1). Next, the user sets the mobile terminal 20 to the reader 32 (step S2). The mobile terminal 20 executes the carrying thing search as needed. The carrying thing search is a process to confirm the belongings of the user, and specifically the mobile terminal 20 detects the carrying things (belongings) in which the RFID and the like is embedded. By checking the carrying things, it becomes possible to presume the purpose of the user's driving hereafter to some extent.

Next, the mobile terminal 20 inquires of the navigation apparatus 30 the destination (step S3). In response, the navigation apparatus 30 returns the information of the destination and the searched route to the mobile terminal 20 (step S4) . The mobile terminal 20 requests the related information from the life log server 10 based on the information of the destination and the searched route. This request includes the ID information and the information of the destination and/or the searched route (hereinafter referred to as “route information”).

The life log server 10 searches the life log DB 12 based on the route information included in the request of the related information (step S6), and extracts the related information to transmit it to the navigation apparatus 30 (step S7). This related information includes the place information of the related facility.

Next, the navigation apparatus 30 displays the candidates of the stop-by place on the monitor 31 based on the received related information (step S8). When the user selects the stop-by place in response (step S9), the navigation apparatus 30 executes the route guidance including the selected stop-by place. In addition, the navigation apparatus 30 regards the user's selection of the stop-by place as the user's behavior, and transmits it to the life log server 10. The life log server 10 registers it in the life log DB 12 as the life log data (step S10). Thus, the navigation apparatus 30 can present, to the user, the places related to the destination set by the user or the searched route as well as the user's own life log data, as the candidate of the stop-by place.

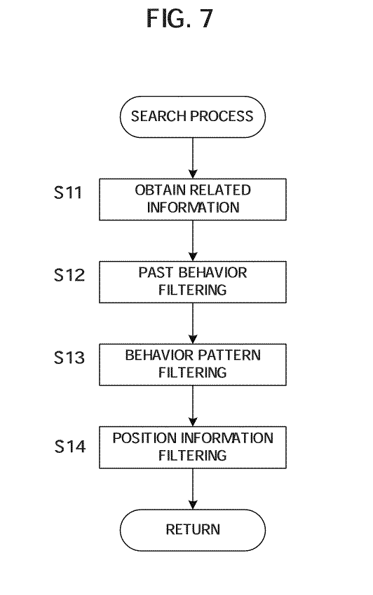

Next, the search process of step S6 will be described in detail. FIG. 7 is a flowchart of an example of the search process. In this example, first the life log server 10 accesses the behavior linkage information DB 13 shown in FIG. 5B and the related information DB 14, and obtains the related information related to the goods, the contents and the behaviors registered in the user's life log data (step S11).

Next, the life log server 10 refers to the life log data, and executes the filtering of the related information obtained in step S11 in consideration of the user's behaviors in the past and the behavior patterns. Specifically, the life log server 10 executes the past behavior filtering (step S12) and the behavior pattern filtering (step S13). The “past behavior filtering” is the filtering based on the user's past life log data. For example, if the user has bought a wetsuit, the past behavior filtering excludes the shop of the wetsuit from the related information. On the other hand, the “behavior pattern filtering” is to presume the user's next behavior based on the behavior of other user having a similar behavior history, thereby to narrow down the related information.

Next, the life log server 10 narrows down and outputs the related information at the user's current position or around the current guiding route, based on the route information included in the request of the related information (Position information filtering: step S14). Thus, the search process extracts the related information which relates to the behavior history included in the user's life log data and which is close to the current position or the current route. It is noted that FIG. 7 is an example of the search process, and the order of the filtering is not limited to this. Other filtering method may be applied to narrow down the related information.

[Concrete Example of Navigation]

Next, the description will be given of the concrete example of the navigation utilizingthe life log. In the following example, the navigation apparatus 30 executes the navigation based on the life log registered when the user purchases the surfboard.

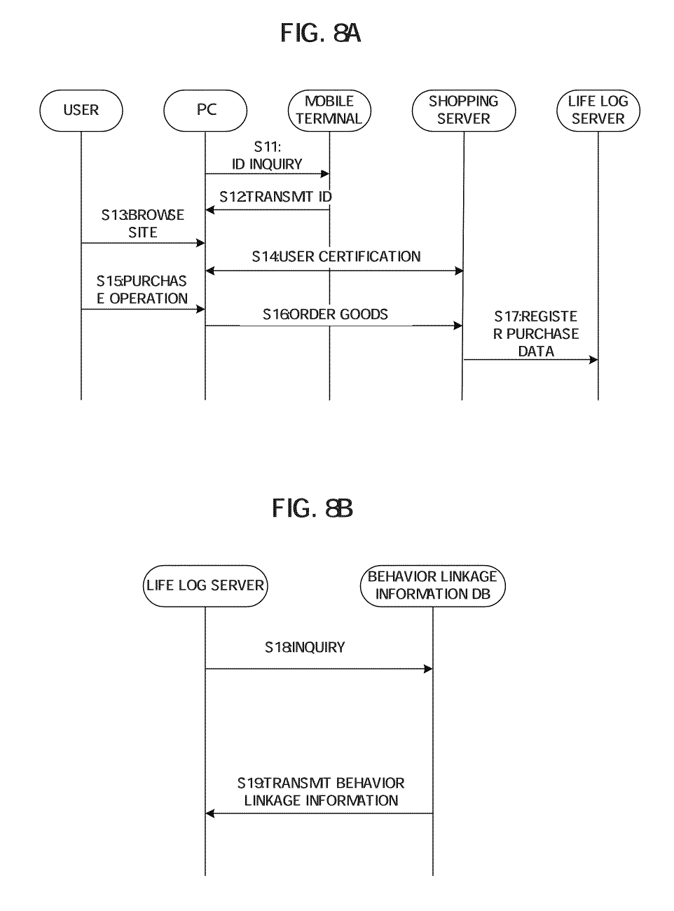

FIG. 8A shows the process at the time of the purchase. In this example, the user purchases the surfboard by the internet shopping using the electronic money. First, the user places the mobile terminal 20 to the reader of the PC, before the purchase procedure or according to the guidance of the purchase procedure. By this, the PC reads out the ID information from the mobile terminal 20 (step S11, S12), and the user browses the site (step S13).

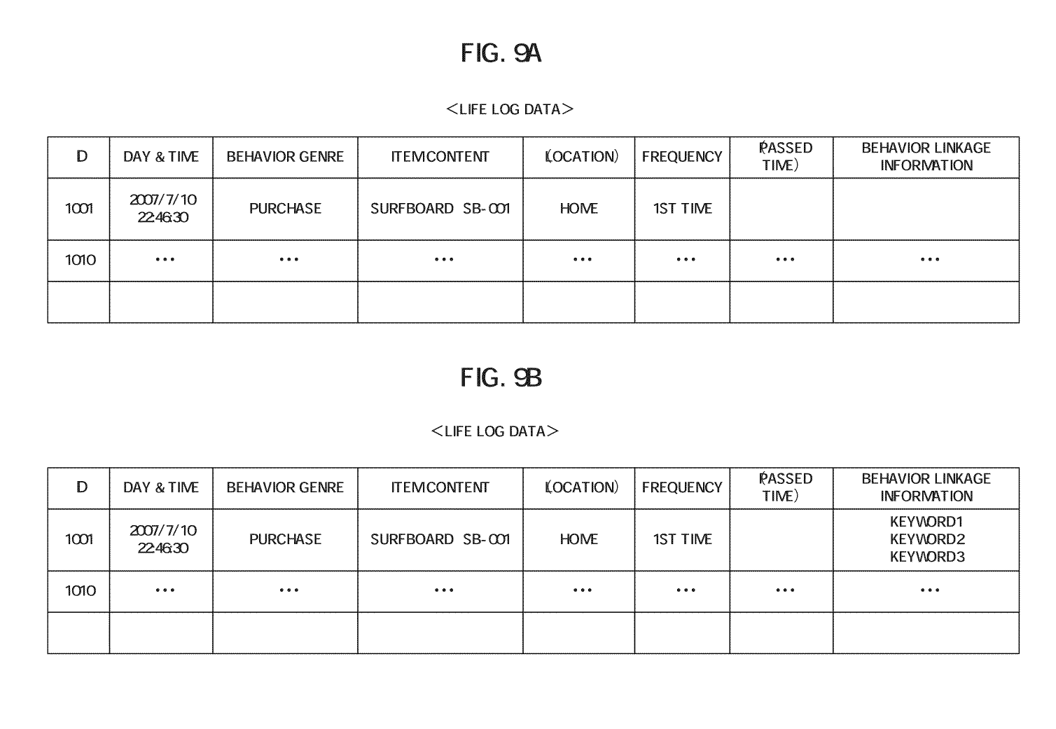

Next, the PC executes the user certification with the shopping server using the ID information obtained from the mobile terminal 20 (step S14) . When the user certification is completed, the user selects a favorite surfboard, and performs the purchase operation (step S15). The PC transmits the order of the item to the shopping server (step S16). In addition, the shopping sever automatically transmits the purchase information to the life log server 10 and makes the purchase information registered as the life log data (step S17). Thus, the life log data is registered in the life log DB 12 of the life log server 10 as shown in FIG. 9A.

When the purchase information is registered in the life log server 10, the life log server 10 makes the inquiry to the behavior linkage information DB 13 as shown in FIG. 8B (step S18). The behavior linkage information in the behavior linkage information DB 13 is classified into plural categories, and the behavior linkage information DB 13 extracts the behavior linkage information of the category close to the type of the user and transmits it to the life log server 10 (step S19). In this example, the extracted behavior linkage information is “KEYWORDS 1 to 3”, and they are transmitted to the life log server 10. The life log server 10 stores the received behavior linkage information in the life log DB 12. By this, as shown in FIG. 9B, “KEYWORDS 1 to 3” are added to the column of the behavior linkage information of the life log data in the life log DB 12.

As described above, when the user purchases the surfboard, the corresponding life log data is stored in the life log DB 12 as shown in FIG. 9B.

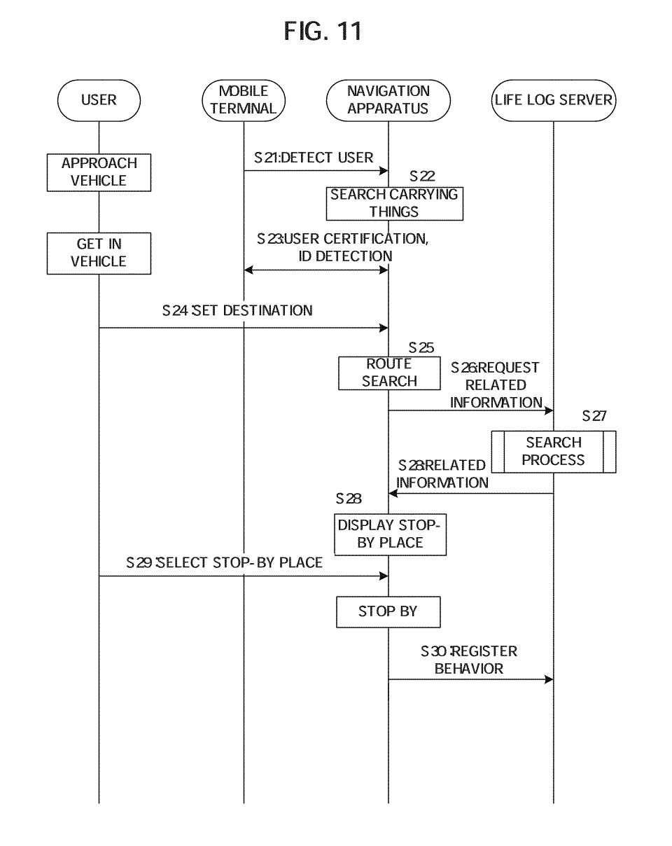

Next, the navigation process using this life log data will be described. FIG. 11 is a flowchart of the navigation process. The user approaches and gets in the vehicle with carrying the mobile terminal 20. At this time, the navigation apparatus 30 executes the short-range wireless communication such as Bluetooth (Registered Trademark) with the mobile terminal 20 to detect that the user is approaching (step S21). The navigation apparatus 30 searches the user's carrying things by the RFID reader or the like not shown (step S22). This search can be done by the vehicle itself, instead of the navigation apparatus 30. Next, the navigation apparatus 30 obtains the ID information from the mobile terminal 20 by the short-range wireless communication, and executes the user certification (step S23).

Next, the user sets the destination (step S24), and the navigation apparatus 30 executes the route search in response (step S25). The navigation apparatus 30 transmits the route information and the ID information to the life log server 10 and request the related information (step S26). The life log server 10 executes the search process in accordance with the request of the related information (step S27).

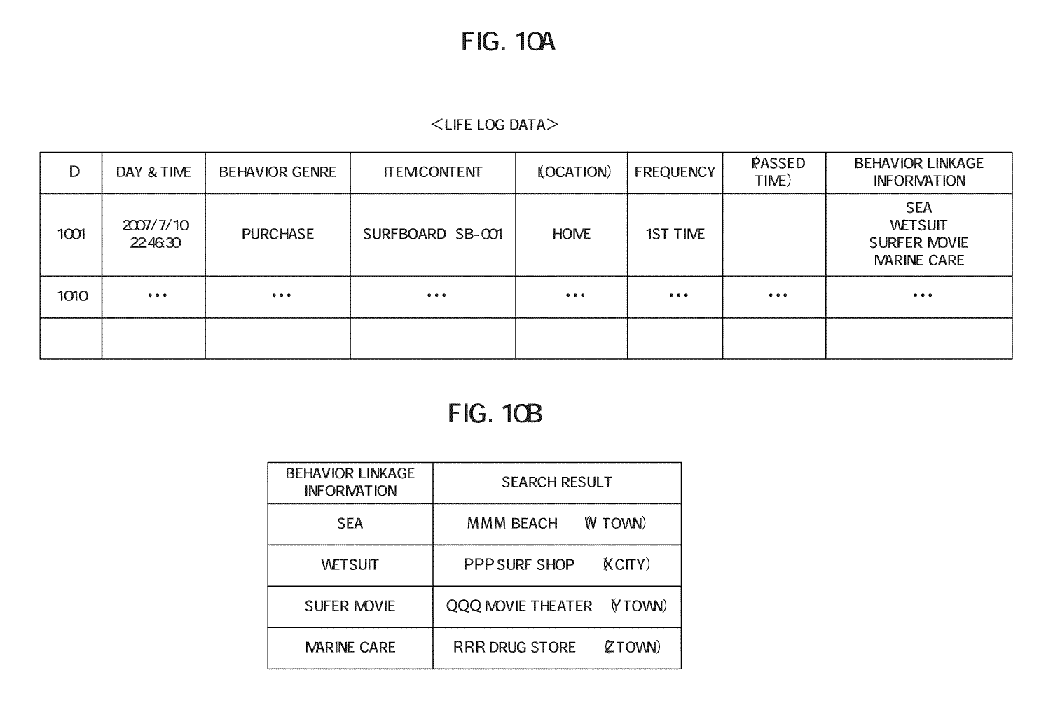

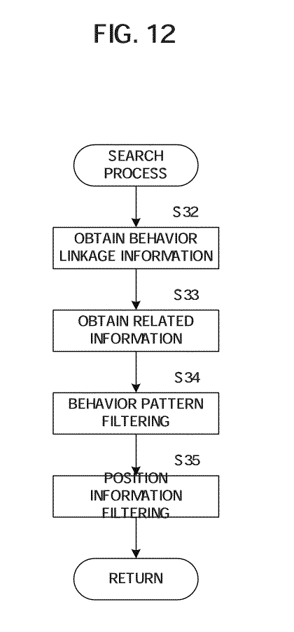

The detail of the search process is shown in FIG. 12. The life log server 10 selects the life log data from the life log DB 12 based on the ID information, and extracts the behavior linkage information of the selected life log data (step S32). In this example, in accordance with the behavior linkage information shown in FIG. 5B, the life log server 10 obtains “SEA”, WETSUIT”, “SURFER MOVIE” and “MARINE CARE” as the behavior linkage information corresponding to the item “SURFBOARD” in the life log data, as shown in FIG. 10A.

Next, the life log server 10 refers to the related information DB 14, and obtains the related information corresponding to the obtained behavior linage information (step S33). In this example, plural related information are obtained according to the example of the relate information shown in FIG. 5C.

Next, the life log server 10 deletes unnecessary information from the plural related information based on the user's behavior history until then (Behavior pattern filtering: step S34). In addition, the life log server 10 deletes the information far from the current position or the searched route, based on the route information included in the request of the related information and the place information (the latitude/longitude information, the address, the post code, the telephone number, etc.) included in each related information (Position information filtering: step S35) . The related information thus narrowed down are transmitted from the life log server 10 to the navigation apparatus 30 (step S28) . The search result of the related information obtained in this example is shown in FIG. 10B. In this way, based on the life log data indicating that the user purchased the surfboard, the navigation apparatus 30 can present four places as the candidates of the stop-by place.

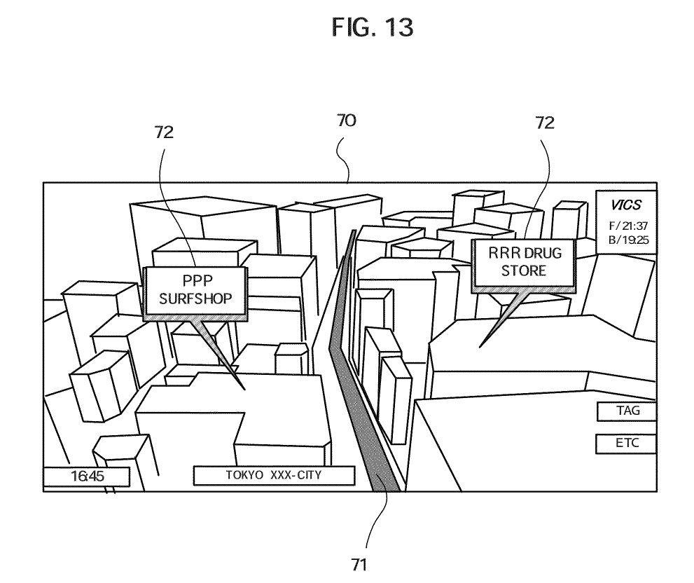

The navigation apparatus 30 displays the places corresponding to the related information obtained from the life log server 10 on the monitor 31 as the candidates of the stop-by place (step S28). FIG. 13 shows an example of displaying the candidates of the stop-by place. In the example of FIG. 13, the guiding route 71 is shown in the display screen 70 of the monitor 31, and the candidates of the stop-by place are shown by the balloons 72.

When the user selects a certain stop-by place from the displayed candidates (step S29), the navigation apparatus 30 adds the stop-by place to the current guiding route. After that, when the user starts driving and stops by the stop-by place, the navigation apparatus 30 transmits it to the life log server 10 as the user's behavior history (step S30), and the life log server 10 registers it as the life log data of the user.

[Navigation Process Utilizing Plural Users]

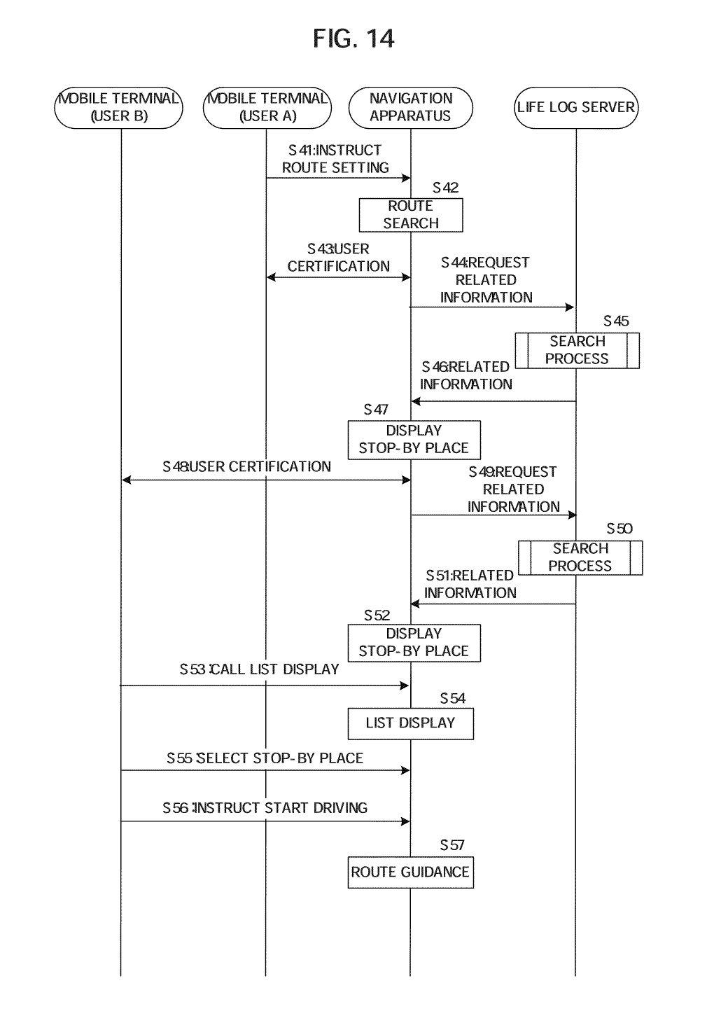

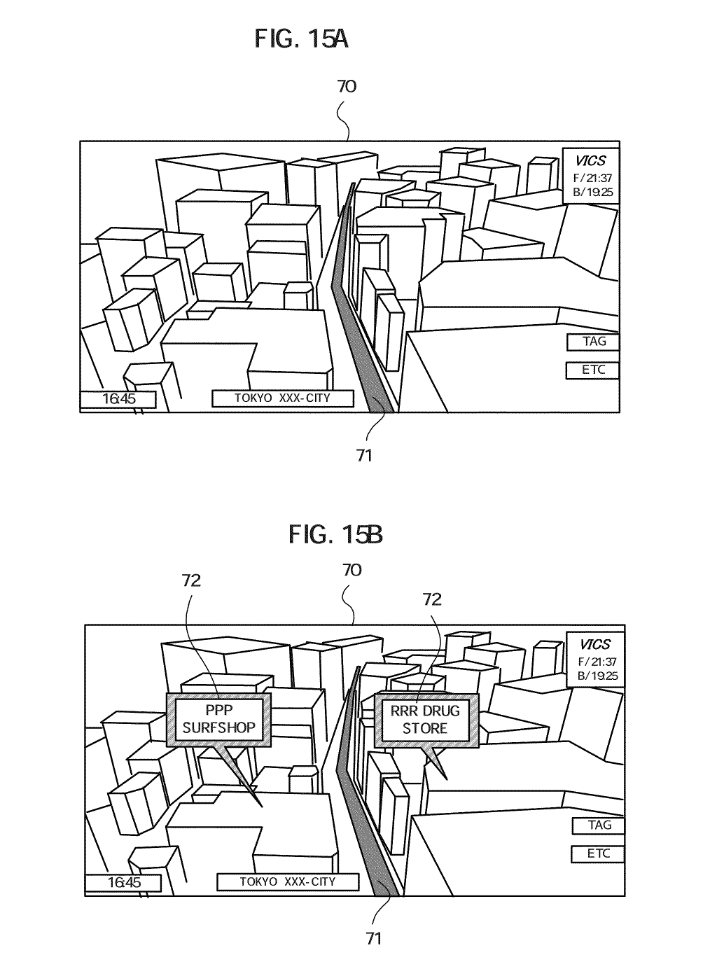

Next, the navigation process utilizing the life log data of plural users will be described. In this example, in the vehicle shown in FIG. 2, the navigation process is executed utilizing the life log data of the user A who is the driver and the life log data of the user B who is a passenger. FIG. 14 shows the flow of the navigation process in this case, and the display examples on the monitor 31 are shown in FIGS. 15 to 17.

First, the user A operates the navigation apparatus 30 to designate the destination and instruct the route setting (step S41). The navigation apparatus 30 executes the route search to the destination designated by the user A, and displays the guiding route on the monitor 31 (step S42). FIG. 15A is a display example at this time, and the guiding route 71 is shown on the map displayed on the display screen 70.

Next, the user A puts his or her mobile terminal 20 on the reader 32. The reader 32 reads out the ID information from the mobile terminal 20 of the user A to transmit it to the navigation apparatus 30, and executes the user certification with the navigation apparatus 30 (step S43). Instead of using the reader 32, the mobile terminal 20 may execute the user certification by communication with the navigation apparatus 30 by the wireless communication function.

When the user certification is completed, the navigation apparatus 30 transmits the request for the related information including the ID information of the user A and the route information (step S44). The life log server 10 executes the search process in the order shown in FIG. 12 for example (step S45), and transmits the related information to the navigation apparatus 30 (step S46). Thus, the navigation apparatus 30 obtains the related information relating to the life log data of the user A, and displays the candidates of the stop-by place on the monitor 31 based on the related information (step S47). FIG. 15B shows the display example at this time. In the display screen 70, two candidates of the stop-by place related to the life log data of the user A are shown by the balloons 72. The user A and B can select the balloons 72 displayed on the display screen 70 one by one and make them magnified to confirm their details.

Next, the user B who is the passenger puts his or her mobile terminal 20 on the reader 32. The reader 32 reads out the ID information from the mobile terminal 20 of the user B to transmit it to the navigation apparatus 30, and executes the user certification with the navigation apparatus 30 (step S48).

When the user certification is completed, the navigation apparatus 30 transmits the request for the related information including the ID information of the user B and the route information (step S49). The life log server 10 executes the search process in the order shown in FIG. 12 for example (step S50), and transmits the related information to the navigation apparatus 30 (step S51). Thus, the navigation apparatus 30 obtains the related information relating to the life log data of the user B, and displays the candidates of the stop-by place on the monitor 31 based on the related information (step S52).

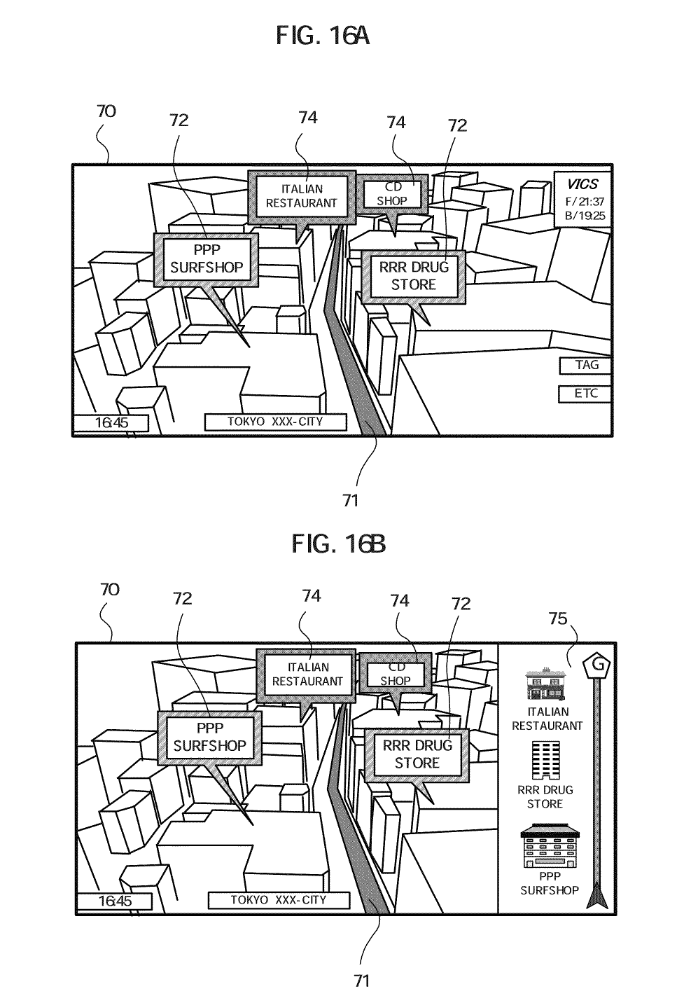

FIG. 16A shows the display example at this time. In the display screen 70, two candidates of the stop-by place related to the life log data of the user B are shown by the balloons 74. Hereinafter, the users A and B are simply referred to as “user” if the users A and B are not needed to be discriminated from each other.

The user can select the balloons 72 and 74 displayed on the display screen 70 one by one and make them magnified to confirm their details. The balloons 72 of the stop-by place related to the life log data of the user A and the balloons 74 of the stop-by place related to the life log data of the user B are displayed in a different manner to be distinguished from each other, for example, displayed by the display frame of different colors or by different marks. In FIGS. 16A and 16B, the hatching at the display frames of the balloons 72 and 74 are different. In this way, by differentiating the display manner of the candidates of the stop-by place for each user to be distinguished from each other, the user watching the display screen 70 can understand which candidate of the stop-by place relates to the life log data of which user at a glance.

Next, the user operates the controller 34 to call out the list display (step S53). If the monitor 31 is a touch panel, the user may call out the list display by touching the monitor 31. The navigation apparatus 30 displays the list display on the display screen 70 (step S54). FIG. 16B shows the display example at this time. The list display area 75 is displayed on the right side of the display screen 70. In the list display area 75, the icons of the candidates of the stop-by place shown by the balloons 72 and 74 are displayed in the traveling order on the guiding route.

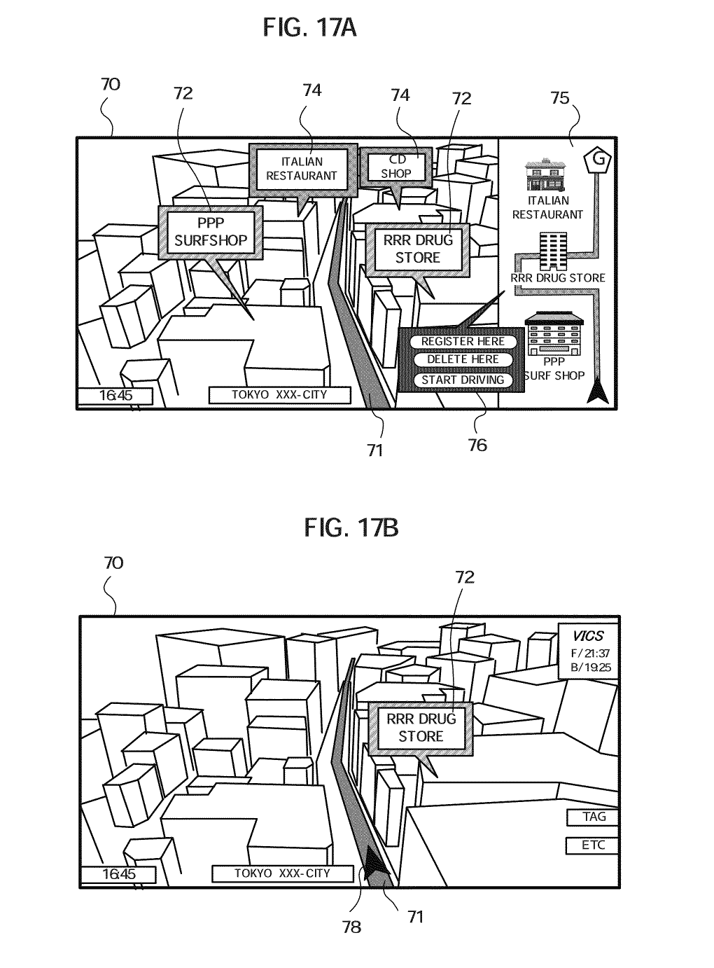

The user operates the controller 34 to select the stop-by place (step S55). FIG. 17A shows the display example when the “RRR DRAG STORE” is selected as the stop-by place. Specifically, when the user selects the candidate of a certain stop-by place, the input window 76 is displayed. When the user selects “REGISTER HERE” from the options in the input window 76, the candidate of the stop-by place is registered as shown in the list display area 75. In this way, the user can select the candidates of some stop-by places to add them to the guiding route, as needed. When the user selects “DELETE HERE” from the options in the input window 76, the stop-by place is deleted from the guiding route.

After that, when the user selects “START DRIVING” in the input window 76 (step S56), the navigation apparatus executes the route guidance according to the guiding route (step S57). This guiding route includes the stop-by place that the user selected in step S55. FIG. 17B shows the display example of the display screen 70 during the route guidance. The balloon 72 corresponding to the stop-by place added by the user is displayed. The current position mark 78 is displayed on the new guiding route 71.

### MODIFIED EXAMPLE

While the navigation process is executed by utilizing the life log data of two users in the above example, the navigation process may be executed by utilizing the life log data of one, three or more users. In that case, the candidates of the stop-by place presented based on the life log data of each of the users are displayed in a manner distinguished from each other.

In the navigation system of the present invention, the communication between the navigation apparatus 30 and the life log server 10 may be performed by using the communication function of the navigation apparatus 30, and may be performed by using the communication function of the mobile terminal 20. Specifically, in the example of FIG. 6, the request for the related information (step S5) is made by using the communication function of the mobile terminal 20. On the other hand, in the example of FIG. 11, the request for the related information is made by using the communication function of the navigation apparatus 30 (step S26).

The above embodiment includes one life log server. However, there is a case that plural life log servers exist in reality, and the life log server is different for each user in that case. Therefore, in order to connect to the life log server to obtain the related information, the server name, the IP address and the certification information are needed as the connection information.

### INDUSTRIAL APPLICABILITY

This invention can be used for a navigation apparatus capable of communicating with the server.

1-7. (canceled)

8. A navigation apparatus capable of communicating with a server apparatus, comprising:
an ID information obtaining unit which obtains ID information of plural users, the ID information identifying a user;
a related information requesting unit which transmits a related information request that includes the ID information and that requests related information;
a receiving unit which receives, from the server apparatus, the related information that is obtained by searching life log data of each of the plural users based on the ID information included in the related information request and that includes place information related to each of the plural users; and
a display control unit which displays a place related to each of the plural users included in the related information received from the server apparatus, as a candidate of stop-by place, on a same map screen in a manner different and distinguished from each other.

9. The navigation apparatus according to claim 8,
wherein the related information request includes route information, and
wherein the receiving unit receives, from the server apparatus, the related information which is narrowed down based on the route information.

10. The navigation apparatus according to claim 8, wherein the display control unit displays the candidate of each stop-by place by a balloon associated with a corresponding geographic position on a map.

11. The navigation apparatus according to claim 8, wherein the display control unit displays a list display area which displays the candidate of each stop-by place as a list in a traveling order indicated by the route information.

12. A non-transitory computer-readable medium storing a navigation program executed by a computer in a navigation apparatus capable of communicating with a server apparatus, the program causing the computer to function as:
an ID information obtaining unit which obtains ID information of plural users, the ID information identifying a user;
a related information requesting unit which transmits a related information request that includes the ID information and that requests related information;
a receiving unit which receives, from the server apparatus, the related information that is obtained by searching life log data of each of the plural users based on the ID information included in the related information request and that includes place information related to each of the plural users; and
a display control unit which displays a place related to each of the plural users included in the related information received from the server apparatus, as a candidate of stop-by place, on a same map screen in a manner different and distinguished from each other.

13. A navigation system comprising a navigation apparatus and a server apparatus,
wherein the navigation apparatus comprises:
an ID information obtaining unit which obtains ID information of plural users, the ID information identifying a user;
a related information requesting unit which transmits a related information request that includes the ID information and that requests related information;
a receiving unit which receives, from the server apparatus, the related information corresponding to the related information request; and
a display control unit which displays places related to each of the plural users included in the related information received from the server apparatus, as a candidate of stop-by place, on a same map screen in a manner different and distinguished from each other,
wherein the server apparatus comprises:
a life log database which stores life log data indicating behavior history of a user;
a receiving unit which receives the related information request from the navigation apparatus;
a search unit which searches the life log data of each of the plural users based on the ID information included in the related information request, and obtains the related information including place information related to each of the plural users; and
a transmitting unit which transmits the related information to the navigation apparatus.
